(19) United States
(12) Patent Application Publication
(10) Pub. No.: US 2022/0092594 A1
(43) Pub. Date: Mar. 24, 2022

(54) METHOD AND DEVICE FOR OPERATING A DISTRIBUTED APPLICATION

(71) Applicant: Robert Bosch GmbH, Stuttgart (DE)

(72) Inventor: Alexander Poddey, Wiernsheim (DE)

(21) Appl. No.: 17/445,986

(22) Filed: Aug. 26, 2021

(30) Foreign Application Priority Data
Sep. 23, 2020 (DE) 102020211936.8

(51) Int. Cl. G06Q 20/40; G06Q 20/06; H04L 29/08

(52) U.S. Cl. CPC G06Q 20/401; H04L 67/142; H04L 67/02; G06Q 20/065

(57) ABSTRACT

A method for operating an application distributed between a first system, a second system, and a third system on a transaction channel shared by the systems. In the method, the third system consents to a state transition of the application under particular conditions, the first system and the second system initiate by mutual agreement the state transition via the transaction channel, and the application carries out the state transition automatically if the conditions are present.

### CROSS REFERENCE

The present application claims the benefit under 35 U.S.C. § 119 of German Patent Application No. DE 102020211936.8 filed on Sep. 23, 2020, which is expressly incorporated herein by reference in its entirety.

### FIELD

The present invention relates to a method for operating a distributed application. The present invention also relates to a corresponding device, to a corresponding computer program as well as to a corresponding memory medium.

### BACKGROUND INFORMATION

Any protocol in computer networks that initiates a consensus with respect to the sequence of particular transactions is referred to as a decentralized transaction system, a transaction database or a distributed ledger. One common form of such a system makes use of a blockchain.

The consensus method most frequently used according to the related art provides a proof of work (PoW) for the generation of new valid blocks. In order to counteract excessive energy consumption caused by producing such proofs, and an unnecessary expansion of the blockchain, so-called transaction channels or state channels have been provided and generalized. An overview of this technology is provided by COLEMAN, Jeff, HORNE, Liam, XUANJI, Li, “Counterfactual: Generalized state channels,” 2018. German Patent Application No. DE 102018210224 A1 describes in the specific embodiment the following method for agreeing to a collaboration between two systems. The first system sends its assumptions with respect to the second system and its guarantees granted to the second system; conversely, the second system sends its assumptions with respect to the first system and guarantees granted to it. A transaction database receives these mutual assumptions and guarantees, checks whether they correspond to one another, if necessary, draws up a digital security contract to be concluded between the systems and, finally, documents the security contract by adding a corresponding block to a blockchain. It then sends the block with the security contract to both systems, which start the collaboration once they receive the block. The systems establish a mutual transaction channel for this purpose on which they exchange pieces of information and signed messages after the block is received. If one of the systems receives a piece of information violating the security contract, it asks the transaction database for arbitration. The transaction database notifies the other system of the arbitration, requests from the other system the information—allegedly violating the security contract—and checks the latter based on the security contract.

Such intelligent contracts (smart contracts) embody the transactional logic of every distributed application, dApp, of a transaction database. German Patent Application No. DE 102017214902 A1, for example, describes an intelligent contract for providing and/or executing transactions between an owner of a terminal and a service provider, the intelligent contract including conditions of the service provider for services of an information service provider, in particular, conditions regarding utilization fees, preferably a road toll, and/or for services of a service provider, in particular, conditions regarding license fees, preferably regarding parking fees, refueling fees, fees of a charging station for the terminal and/or conditions of an insurance and/or conditions regarding user fees, preferably regarding fees for the shared use of the terminal for providing and/or aborting a service and/or conditions defined by the owner of this terminal for an acceptance and/or termination of the service, the intelligent contract being executed in an authorization node of a computer network based on a blockchain.

### SUMMARY

The present invention provides a method for operating a distributed application, a corresponding device, a corresponding computer program as well as a corresponding machine-readable memory medium.

In order to configure an instance of a dApp operating outside the chain and to carry out state transitions off-chain, all systems constituting the network or a particular subset thereof must sign the targeted transition in order in this respect to achieve and prove a consensus. These signed off-chain states may then be used in case of dispute in order to reach an agreement with respect to the resulting state of the entire chain—normally the state actually signed by the required channel users.

Against this background, the approach described below in accordance with an example embodiment of the present invention recognizes the problem that the user of a state channel or transaction channel according to the related art is itself forced to sign agreed states or transactions or to transfer this task, if necessary, to a representative within the same network empowered to sign, to whom, however, the private key of the user to be represented would have to be divulged for this purpose. This means that the user or its representative decides upon the signing of a proposed transaction or of a new state. In hierarchically modular forms of generalized state channels—referred to in the present context as transaction channel networks—it may occur, however, that a signature must be compelled due to an existing obligation of third parties, whose legitimate interest in a state transition in the channel network at this point in time may in individual cases differ from that of the obligated party. The same applies if the intended signer is separated (offline) from the transaction channel network.

Against this background, the provided approach in accordance with an example embodiment of the present invention differentiates the purpose and effect of the signature as such—namely the marking of a state or state transition as recognized by the respective signer—from the process of signing by expanding the latter as follows: The signature executed by the relevant user or by its representative itself may be omitted under defined conditions if the user has issued its consent to state transitions which meet these conditions.

The approach according to the present invention thus overcomes the requirement that all users are either online or utilize complex technologies in order to hold in readiness, in particular, transaction channel networks for complex dApps, and to prevent them and the network of channels connecting them from having to be added to the chain. For this purpose, the users are granted the option of expressing in a forgery-proof and comprehensible manner their intention of securing automatically countersigned dApp state transitions for particular transitions or types of transitions in the complex dApp logic.

Advantageous refinements of and improvements on the basic embodiment of the present invention are possible with the measures disclosed herein.

### BRIEF DESCRIPTION OF THE DRAWINGS

Exemplary embodiments of the present invention are represented in the figures and explained in greater detail in the description below.

FIG. 1 shows a flowchart of a method according to one first specific embodiment of the present invention.

FIG. 2 schematically shows a control unit according to one second specific embodiment of the present invention.

### DETAILED DESCRIPTION OF EXAMPLE EMBODIMENTS

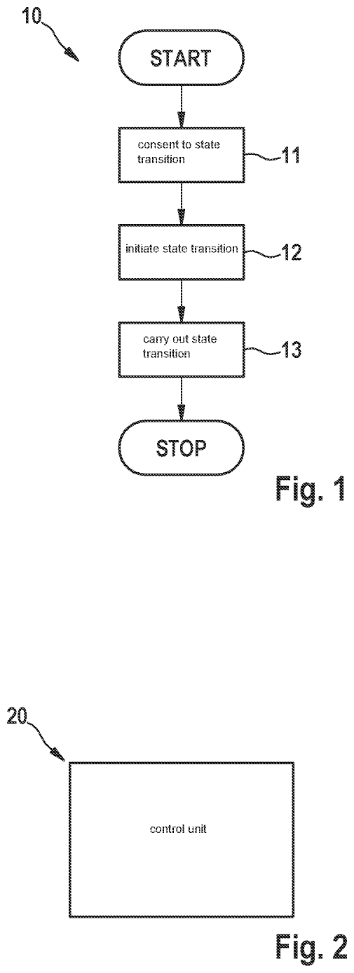

FIG. 1 illustrates the basic sequence of a method 10 according to the present invention, which is now explained based on the following application example: a complex dApp is provided distributed between five systems A through E, within the scope of which a sequence of moves generates currency transactions or other state transitions, which affect only systems A and B. It is further assumed that systems C, D, and E—in a form previously agreed upon between all systems—would have consented to all state transitions of the application not affecting them (process 11).

In this initial scenario, A and B, for example, now initiate via the shared transaction channel a transition of the dApp (process 12), which each relates solely to their individual state, but not to the state of systems C through E. In this case, the transition completed and countersigned solely by A and B represents a valid transition, which is also able to be proven unequivocally in the blockchain (on-chain), since in the present case the condition would have been met.

This method 10 may be implemented in software or in hardware or in a mixed form of software and hardware, for example, in a control unit 20, as illustrated by the schematic representation of FIG. 2.

Example embodiments of the present invention are set forth in the following numbered paragraphs.

Paragraph 1. A method (10) for operating an application distributed between a first system, a second system, and a third system on a transaction channel shared by the systems, characterized by the following features:
the third system consents (11) to a state transition of the application under particular conditions,
the first system and the second system initiate (12) by mutual agreement the state transition via the transaction channel and
the application carries out the state transition automatically (13) if the conditions are present.

Paragraph 2. The method (10) as recited in Paragraph 1, characterized by the following feature:
the transaction channel is anchored in a blockchain.

Paragraph 3. The method (10) as recited in Paragraph 2, characterized by the following features:
the first system, the second system and the third system use a shared script language and
the presence of the conditions is checked in the script language.

Paragraph 4. The method (10) as recited in Paragraph 3, characterized by the following features:
the conditions relate to a shared oracle and
the check includes a call-up of the oracle.

Paragraph 5. The method (10) as recited in one of Paragraphs 2 through 4, characterized by the following features:
the state transition marks a financial transaction in a shared cryptocurrency and
the blockchain serves the systems as a distributed ledger of the cryptocurrency.

Paragraph 6. The method (10) as recited in one of paragraphs 1 through 5, characterized by at least one of the following features:
the first system and the second system are identical,
the first system and the third system are identical, or
the second system and the third system are identical.

Paragraph 7. A computer program, which is configured to carry out the method (10) as recited in one of Paragraphs 1 through 6.

Paragraph 8. A machine-readable memory medium, on which the computer program as recited in Paragraph 7 is stored.

Paragraph 9. A device, which is configured to carry out the method (10) as recited in one of Paragraphs 1 through 6.

What is claimed is:

1. A method for operating an application distributed between a first system, a second system, and a third system on a transaction channel shared by the first, second, and third systems, the method comprising the following steps:
consenting, by the third system, to a state transition of the application under particular conditions;
initiating, by the first system and the second system, by mutual agreement the state transition via the transaction channel; and
carrying out, by the application, the state transition automatically when the conditions are present.

2. The method as recited in claim 1, wherein the transaction channel is anchored in a blockchain.

3. The method as recited in claim 2, wherein the first system, the second system, and the third system use a shared script language, and the presence of the conditions is checked in the script language.

4. The method as recited in claim 3, wherein the conditions relate to a shared oracle, and the check includes a call-up of the oracle.

5. The method as recited in claim 2, the state transition marks a financial transaction in a shared cryptocurrency, and the blockchain serves the first, second, and third systems as a distributed ledger of the cryptocurrency.

6. The method as recited in claim 1, wherein:
the first system and the second system are identical, and/or
the first system and the third system are identical, and/or
the second system and the third system are identical.

7. A non-transitory machine-readable memory medium on which is stored a computer program for operating an application distributed between a first system, a second system, and a third system on a transaction channel shared by the first, second, and third systems, the computer program, when executed by a computer, causing the computer to perform the following steps:
consenting, by the third system, to a state transition of the application under particular conditions;
initiating, by the first system and the second system, by mutual agreement the state transition via the transaction channel; and
carrying out, by the application, the state transition automatically when the conditions are present.

8. A device configured to operate an application distributed between a first system, a second system, and a third system on a transaction channel shared by the first, second, and third systems, the device configured to:
consent, by the third system, to a state transition of the application under particular conditions;
initiate, by the first system and the second system, by mutual agreement the state transition via the transaction channel; and
carry out, by the application, the state transition automatically when the conditions are present.
